(19) United States
(12) Patent Application Publication
(10) Pub. No.: US 2016/0274915 A1
(43) Pub. Date: Sep. 22, 2016

(54) PROVIDING LOWER-OVERHEAD MANAGEMENT OF DATAFLOW EXECUTION OF LOOP INSTRUCTIONS BY OUT-OF-ORDER PROCESSORS (OOPs), AND RELATED CIRCUITS, METHODS, AND COMPUTER-READABLE MEDIA

(71) Applicant: QUALCOMM Incorporated, San Diego, CA (US)

(72) Inventors: Karamvir Singh Chatha, San Diego, CA (US); Kevin Weikong Yen, San Diego, CA (US); Rick Seokyong Oh, San Diego, CA (US); John Paul Daniels, San Diego, CA (US); Michael Alexander Howard, Cardiff, CA (US); Francisco Miranda Perez, San Diego, CA (US); Eladio Clemente Arvelo, San Diego, CA (US); Ramesh Chandra Chauhan, San Diego, CA (US)

(21) Appl. No.: 14/743,198

(22) Filed: Jun. 18, 2015

Related U.S. Application Data
(60) Provisional application No. 62/135,738, filed on Mar. 20, 2015.

(51) Int. Cl. G06F 9/38; G06F 9/32

(52) U.S. Cl. CPC G06F 9/3855; G06F 9/3867; G06F 9/325

(57) ABSTRACT

Providing lower-overhead management of dataflow execution of loop instructions by out-of-order processors (OOPs), and related circuits, methods, and computer-readable media are disclosed. In one aspect, a reservation station circuit including multiple reservation station segments, each storing a loop instruction of a computer program loop is provided. Each reservation station segment also stores an instruction execution credit indicator indicative of whether the corresponding loop instruction may be provided for dataflow execution. The reservation station circuit further includes a dataflow monitor providing an entry for each loop instruction, each entry comprising a consumer count indicator and a reservation station (RS) tag count indicator. The dataflow monitor is configured to determine whether all consumer instructions of a loop instruction have executed based on the consumer count indicator and the RS tag count indicator for the loop instruction. If so, the dataflow monitor issues an instruction execution credit to the loop instruction.

### PRIORITY APPLICATION

The present application claims priority to U.S. Provisional Patent Application Ser. No. 62/135,738 filed on Mar. 20, 2015 and entitled “PROVIDING LOWER-OVERHEAD MANAGEMENT OF DATAFLOW EXECUTION OF LOOP INSTRUCTIONS BY OUT-OF-ORDER PROCESSORS (OOPS), AND RELATED CIRCUITS, METHODS, AND COMPUTER-READABLE MEDIA,” the contents of which is incorporated herein by reference in its entirety.

### BACKGROUND

I. Field of the Disclosure

The technology of the disclosure relates generally to dataflow execution of loop instructions by out-of-order processors (OOPs).

II. Background

Many modern processors are out-of-order processors (OOPs) that are capable of dataflow execution of program instructions. Using a dataflow execution approach, the execution order of program instructions by an OOP may be determined by the availability of input data for each program instruction (“dataflow order”), rather than the program order of the program instructions. Thus, the OOP may execute a program instruction as soon as all input data for the program instruction has been generated, which may result in performance gains. For example, instead of having to “stall” (i.e., intentionally introduce a processing delay) while input data is retrieved for an older program instruction, the OOP may proceed with executing a more recently fetched instruction that is able to execute immediately. In this manner, processor clock cycles that would otherwise be wasted may be productively utilized by the OOP.

A conventional OOP may employ an instruction window, which designates a set of program instructions that may be executed out of order. When execution of a program instruction within the instruction window is complete, the results of the execution may be “committed,” or made non-speculative, and the program instruction may be retired from the instruction window to make room for a new program instruction for execution. However, in some circumstances, the eviction of program instructions from the instruction window may result in inefficient operation of the OOP. For example, if the program instructions are part of a loop, the same program instructions may be executed repeatedly over multiple loop iterations. Consequently, the program instructions may be fetched, executed, and retired repeatedly from the instruction window as the loop executes.

Performance of an OOP in the circumstances described above may be improved through the use of reservation station segments. A reservation station segment is an OOP microarchitecture feature that may store a program instruction along with related information required for execution, such as operands. The OOP may load each program instruction associated with a loop into a corresponding reservation station segment. Each reservation station segment may be configured to hold a program instruction for a specified number of loop iterations, rather than retiring the program instruction before the loop has completed. When a reservation station segment determines that all input data for its program instruction is available, the reservation station segment provides the program instruction and its input data to a processor for execution. Only after the loop has completed all iterations are the program instructions associated with the loop retired from the corresponding reservation station segments.

One issue that arises with the use of reservation station segments is managing the production of input data for program instructions with respect to consumption of the input data. If a rate at which a producer instruction generates data is greater than a rate at which a consumer instruction can utilize the data as input, the data may be lost. Alternatively, the use of additional storage or buffer mechanisms may be required, which may be expensive in terms of processor cycles and/or power consumption.

### SUMMARY OF THE DISCLOSURE

Aspects disclosed in the detailed description include providing lower-overhead management of dataflow execution of loop instructions by out-of-order processors (OOPs). Related circuits, methods, and computer-readable media are also disclosed. In this regard, in one aspect, a reservation station circuit for managing dataflow execution of loop instructions in an OOP is provided. The reservation station circuit comprises a plurality of reservation station segments. Each reservation station segment includes a loop instruction register configured to store a loop instruction. Each reservation station segment further includes an instruction execution credit indicator configured to store an instruction execution credit indicative of whether the loop instruction may be provided for dataflow execution. The reservation station circuit further comprises a dataflow monitor comprising a plurality of entries corresponding to the loop instructions of the plurality of reservation station segments. Each entry of the plurality of entries comprises a consumer count indicator indicative of a number of consumer instructions of a corresponding loop instruction, and a reservation station (RS) tag count indicator indicative of a number of executions of the consumer instructions. The dataflow monitor is configured to determine whether all of the consumer instructions of a first loop instruction have executed based on the consumer count indicator and the RS tag count indicator for the first loop instruction. The dataflow monitor is further configured to, responsive to determining that all of the consumer instructions of the first loop instruction have executed, issue an instruction execution credit to a reservation station segment of the first loop instruction. By tracking the execution of consumer instructions and issuing an instruction execution credit to a loop instruction when all consumer instructions of the loop instruction have executed, the dataflow monitor may enable management of dataflow execution of loop instructions without incurring additional overhead, such as additional buffer space.

In another aspect, a method for managing dataflow execution of loop instructions in an OOP is provided. The method comprises determining, by a dataflow monitor, whether all consumer instructions of a first loop instruction have executed. This determination is based on a consumer count indicator of the first loop instruction indicative of a number of the consumer instructions of the first loop instruction, and an RS tag count indicator of the first loop instruction indicative of a number of executions of the consumer instructions The method further comprises, responsive to determining that all of the consumer instructions of the first loop instruction have executed, issuing an instruction execution credit to a reservation station segment corresponding to the first loop instruction.

In another aspect, a non-transitory computer-readable medium is provided, having stored thereon computer-executable instructions. When executed by a processor, the computer-executable instructions cause the processor to determine whether all consumer instructions of a first loop instruction have executed. This determination is based on a consumer count indicator of the first loop instruction indicative of a number of the consumer instructions of the first loop instruction, and an RS tag count indicator of the first loop instruction indicative of a number of executions of the consumer instructions. The computer-executable instructions further cause the processor to issue an instruction execution credit to a reservation station segment corresponding to the first loop instruction, responsive to determining that all of the consumer instructions of the first loop instruction have executed.

### BRIEF DESCRIPTION OF THE FIGURES

FIG. 1 is a block diagram illustrating an exemplary out-of-order processor (OOP) that includes a reservation station circuit managing dataflow execution of loop instructions;

FIG. 2 is a diagram illustrating an exemplary reservation station segment;

FIG. 3 is a block diagram illustrating multiple reservation station segments and the data dependencies between each reservation station segment;

FIG. 4 is a block diagram illustrating entries provided by an exemplary dataflow monitor for the reservation station segments of FIG. 3 for tracking execution of consumer instructions;

FIG. 5 is a chart illustrating instruction execution credits and consumer instruction counts for each reservation station segment of FIG. 3 during an exemplary loop execution;

FIGS. 6A-6B are flowcharts illustrating exemplary operations for providing lower-overhead management of loop instructions in the exemplary OOP of FIG. 1;

FIG. 7 is a block diagram of an exemplary processor-based system that can include the reservation station circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include providing lower-overhead management of dataflow execution of loop instructions by out-of-order processors (OOPs). Related circuits, methods, and computer-readable media are also disclosed. In this regard, in one aspect, a reservation station circuit for managing dataflow execution of loop instructions in an OOP is provided. The reservation station circuit comprises a plurality of reservation station segments. Each reservation station segment includes a loop instruction register configured to store a loop instruction. Each reservation station segment further includes an instruction execution credit indicator configured to store an instruction execution credit indicative of whether the loop instruction may be provided for dataflow execution. The reservation station circuit further comprises a dataflow monitor comprising a plurality of entries corresponding to the loop instructions of the plurality of reservation station segments. Each entry of the plurality of entries comprises a consumer count indicator indicative of a number of consumer instructions of a corresponding loop instruction, and a reservation station (RS) tag count indicator indicative of a number of executions of the consumer instructions. The dataflow monitor is configured to determine whether all of the consumer instructions of a first loop instruction have executed based on the consumer count indicator and the RS tag count indicator for the first loop instruction. The dataflow monitor is further configured to, responsive to determining that all of the consumer instructions of the first loop instruction have executed, issue an instruction execution credit to a reservation station segment of the first loop instruction. By tracking the execution of consumer instructions and issuing an instruction execution credit to a loop instruction when all consumer instructions of the loop instruction have executed, the dataflow monitor may enable management of dataflow execution of loop instructions without incurring additional overhead, such as additional buffer space.

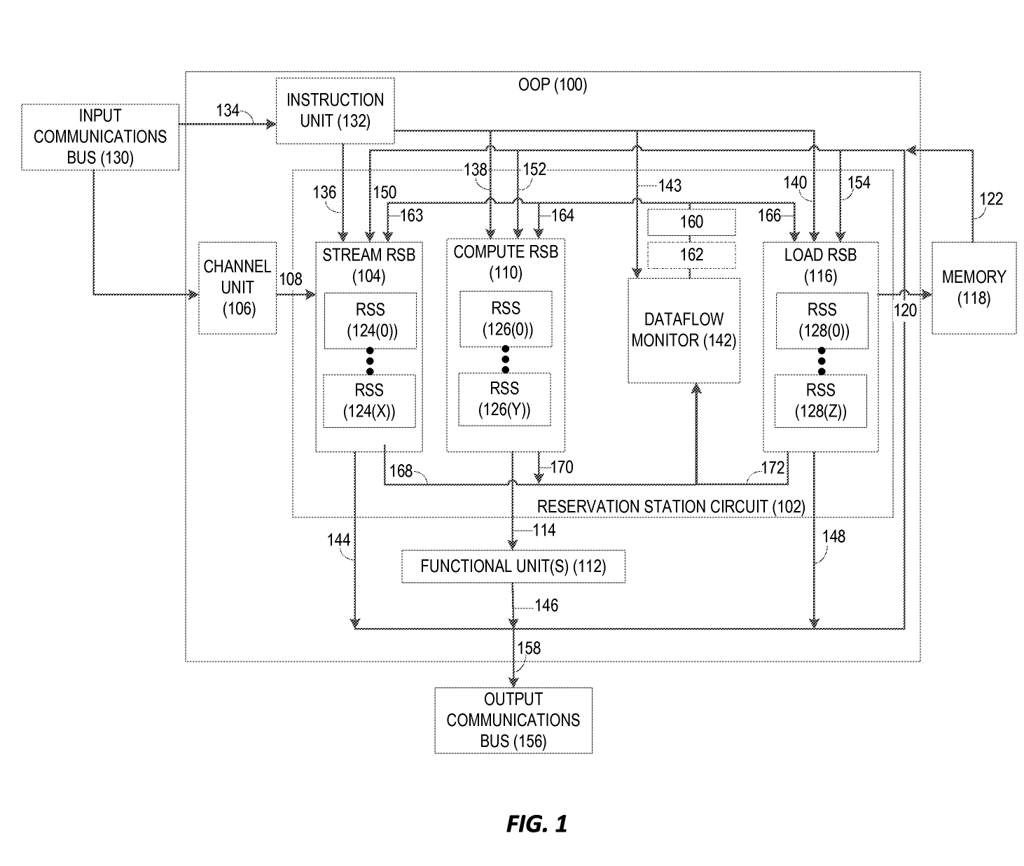

In this regard, FIG. 1 is a block diagram of an OOP 100 configured to provide lower-overhead management of out-of-order dataflow execution of program instructions. In particular, the OOP 100 includes a reservation station circuit 102 for managing dataflow execution of loop instructions. The OOP 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. While FIG. 1 illustrates a single OOP 100, it is to be understood that some aspects may provide multiple, communicatively coupled OOPs 100.

In some environments, an application program may be conceptualized as a “pipeline” of kernels (i.e., specific areas of functionality), wherein each kernel operates on a stream of data tokens passing through the pipeline. The OOP 100 of FIG. 1 may embody a programmable core for implementing the functionality of one or more kernels, and for applying that functionality repeatedly to different sets of data streamed to the OOP 100. To provide kernel functionality in an energy efficient manner, the OOP 100 may provide a process feature referred to herein as “instruction re-vitalization.” Instruction re-vitalization enables a set of program instructions to be loaded together a single time into the OOP 100, and to be subsequently executed multiple times without being retired or evicted from the OOP 100. In this manner, the OOP 100 may execute the set of instructions iteratively on successive data items streamed into the OOP 100. Instruction re-vitalization may thus reduce energy consumption and improve processor performance of the OOP 100 by eliminating the need for a multi-stage execution pipeline. Due to the iterative nature of programming constructs such as loops, instruction re-vitalization may make the OOP 100 especially suited for processing kernels comprising loop instructions.

The OOP 100 is organized into one or more reservation station blocks (also referred to herein as “RSBs”), each of which may correspond to a general type of program instruction. For example, a stream RSB 104 may handle instructions for receiving data streams via a channel unit 106, as indicated by arrow 108. A compute RSB 110 may handle instructions that access one or more functional units 112 (e.g., an arithmetic logic unit (ALU) and/or a floating point unit) for carrying out computational operations, as indicated by arrow 114. Results produced by instructions in the compute RSB 110 may be consumed as input by other instructions in the compute RSB 110. A load RSB 116 handles instructions for loading data from and outputting data to a data store, such as a memory 118, as indicated by arrows 120 and 122. It is to be understood that the OOP 100 may be organized into more than one of each of the stream RSB 104, the compute RSB 110, and/or the load RSB 116. The stream RSB 104, the compute RSB 110, and the load RSB 116 include one or more reservation station segments (also referred to herein as “RSSs”) 124(0-X), 126(0-Y), and 128(0-Z), respectively. Each of the reservation station segments 124(0-X), 126(0-Y), and 128(0-Z) stores a single instruction, along with associated data required for dataflow execution of the resident instruction.

In typical operation, an input communications bus 130 communicates instructions for the kernel to be executed by the OOP 100 to an instruction unit 132 of the OOP 100, as indicated by arrow 134. The instruction unit 132 then loads the instructions into the one or more reservation station segments 124(0-X) of the stream RSB 104 (as indicated by arrow 136), the one or more reservation station segments 126(0-Y) of the compute RSB 110 (as indicated by arrow 138), and/or the one or more reservation station segments 128(0-Z) of the load RSB 116 (as indicated by arrow 140), based on the instruction type. A dataflow monitor 142 may also receive initialization data, such as a number of loop iterations to execute, as indicated by arrow 143.

The OOP 100 may then execute the resident instructions of the reservation station segments 124(0-X), 126(0-Y), and/or 128(0-Z) in any appropriate order. As a non-limiting example, the OOP 100 may execute the resident instructions of the reservation station segments 124(0-X), 126(0-Y), and/or 128(0-Z) in a dataflow execution order. The result (if any) produced by execution of each resident instruction and an identifier for the resident instruction are broadcast by the reservation station segments 124(0-X), 126(0-Y), and/or 128(0-Z), as indicated by arrows 144, 146, and 148, respectively. The reservation station segments 124(0-X), 126(0-Y), and/or 128(0-Z) then receive the broadcast data as input streams (as indicated by arrows 150, 152, and 154, respectively). The reservation station segments 124(0-X), 126(0-Y), and/or 128(0-Z) may monitor the respective input streams indicated by arrows 150, 152, and 154 to identify results from previously executed instructions that are required as input operands (not shown). Once detected, the input operands may be stored, and after all required operands are received, the resident instruction associated with the reservation station segment 124(0-X), 126(0-Y), and/or 128(0-Z) may be provided for dataflow execution. Loop instructions for a loop may thus be iteratively executed in a dataflow manner until the dataflow monitor 142 detects that all iterations of the loop have completed. Data may be streamed out of the OOP 100 to an output communications bus 156, as indicated by arrow 158.

One issue that may arise with the OOP 100 of FIG. 1 is management of the production of input data for instructions with respect to consumption of the input data. If producer instructions generate data at a rate exceeding that at which consumer instructions can utilize the data as input, the data may be lost. This issue may be mitigated through the use of intermediate storage or other buffering mechanisms for input data, but at a cost of additional processor cycles and/or energy consumption.

In this regard, the reservation station circuit 102 of FIG. 1 is provided. The dataflow monitor 142 and the reservation station segments 124(0-X), 126(0-Y), and/or 128(0-Z) of the reservation station circuit 102 coordinate to provide a credit-based system that determines when each instruction is allowed to execute at any given time during a loop iteration. In particular, the dataflow monitor 142 of FIG. 1 operates to ensure that, during loop iterations, a loop instruction is permitted to execute (by, e.g., being issued an instruction execution credit) only if all of its consumer instructions have completed execution. As used herein, a “consumer instruction” refers to a loop instruction that depends on the output of a previous loop instruction (a “producer instruction”) as input. A given loop instruction may thus be both a consumer instruction and a producer instruction.

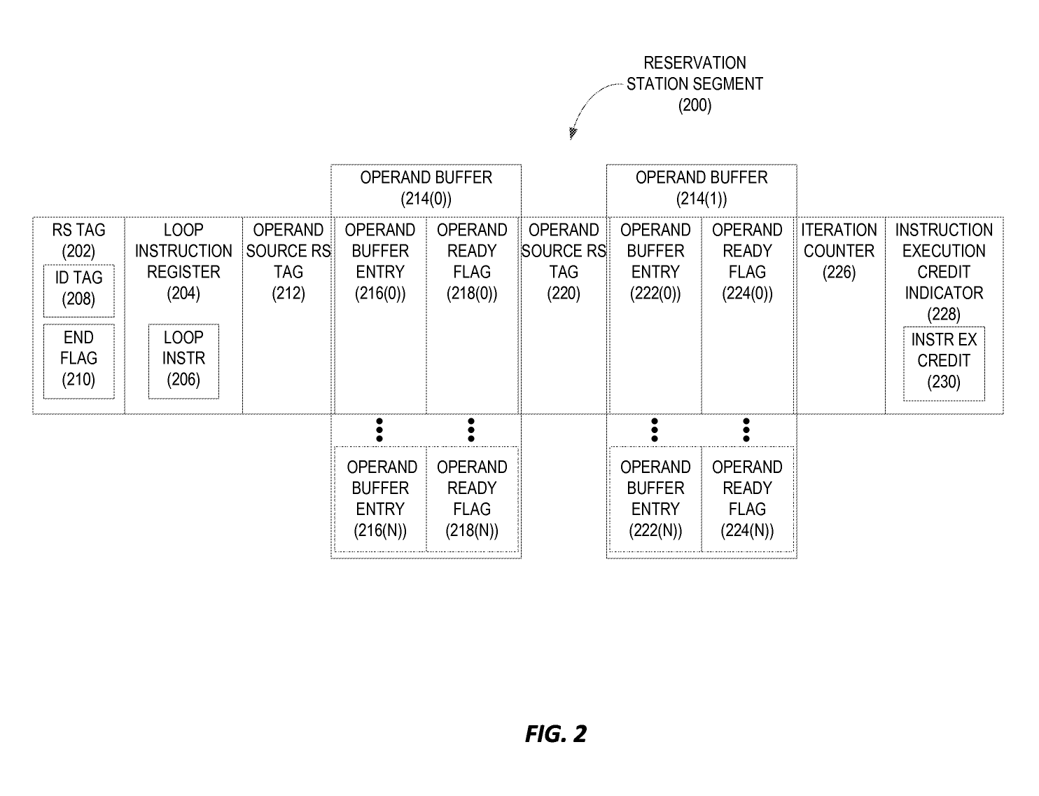

Each of the reservation station segments 124(0-X), 126(0-Y), and 128(0-Z) is associated with an instruction execution credit indicator, discussed in greater detail below with respect to FIG. 2. In some aspects, each instruction execution credit indicator may comprise a counter, and/or may be a flag and/or other state indicator. As part of initialization of the kernel to be executed by the OOP 100, the dataflow monitor 142 may distribute an initial instruction execution credit 160 to each of the reservation station segments 124(0-X), 126(0-Y), and 128(0-Z), as indicated by arrows 163, 164, and 166, respectively. Each of the reservation station segments 124(0-X), 126(0-Y), and 128(0-Z) makes execution of its associated resident loop instruction contingent on the associated instruction execution credit indicator. Stated differently, the associated resident loop instructions may be provided for execution by the reservation station segments 124(0-X), 126(0-Y), and 128(0-Z) only if indicated by the corresponding instruction execution credit indicator. In some aspects in which the instruction execution credit indicator is a counter, the associated resident loop instruction may be provided for execution only if a value of the instruction execution credit indicator is greater than zero (0). In this manner, a producer instruction may be prevented from executing until a consumer instruction is able to “catch up” by consuming the produced input data.

The dataflow monitor 142 is configured to issue an additional instruction execution credit 162 to each of the reservation station segments 124(0-X), 126(0-Y), and 128(0-Z) when all consumer instructions for the associated resident loop instruction have executed. To determine when the additional instruction execution credit 162 may be distributed to the reservation station segments 124(0-X), 126(0-Y), and 128(0-Z), the dataflow monitor 142 maintains entries (not shown) corresponding to each loop instruction associated with the reservation station segments 124(0-X), 126(0-Y), and 128(0-Z). Each entry includes a consumer count indicator (not shown), which is indicative of a number of consumer instructions dependent on the output of the loop instruction. Each entry further includes an RS tag count indicator (not shown), which indicates a number of times that a consumer instruction of the loop instruction corresponding to the entry has executed. As loop instructions of the reservation station segments 124(0-X), 126(0-Y), and 128(0-Z) are executed, the dataflow monitor 142 receives one or more operand source RS tags (not shown) from the reservation station segments 124(0-X), 126(0-Y), and 128(0-Z), as indicated by arrows 168, 170, and 172. Each operand source RS tag identifies a reservation station segment 124(0-X), 126(0-Y), and 128(0-Z) associated with a “producer” loop instruction that generates an operand used by the loop instruction. The dataflow monitor 142 increments the RS tag count indicator for the “producer” loop instruction corresponding to each operand source RS tag to indicate that a consumer instruction of the “producer” loop instruction has executed.

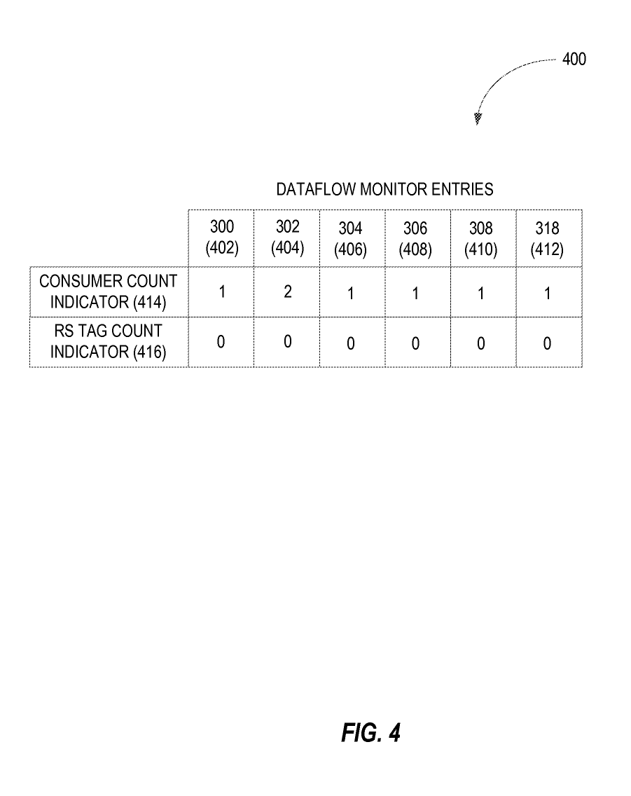

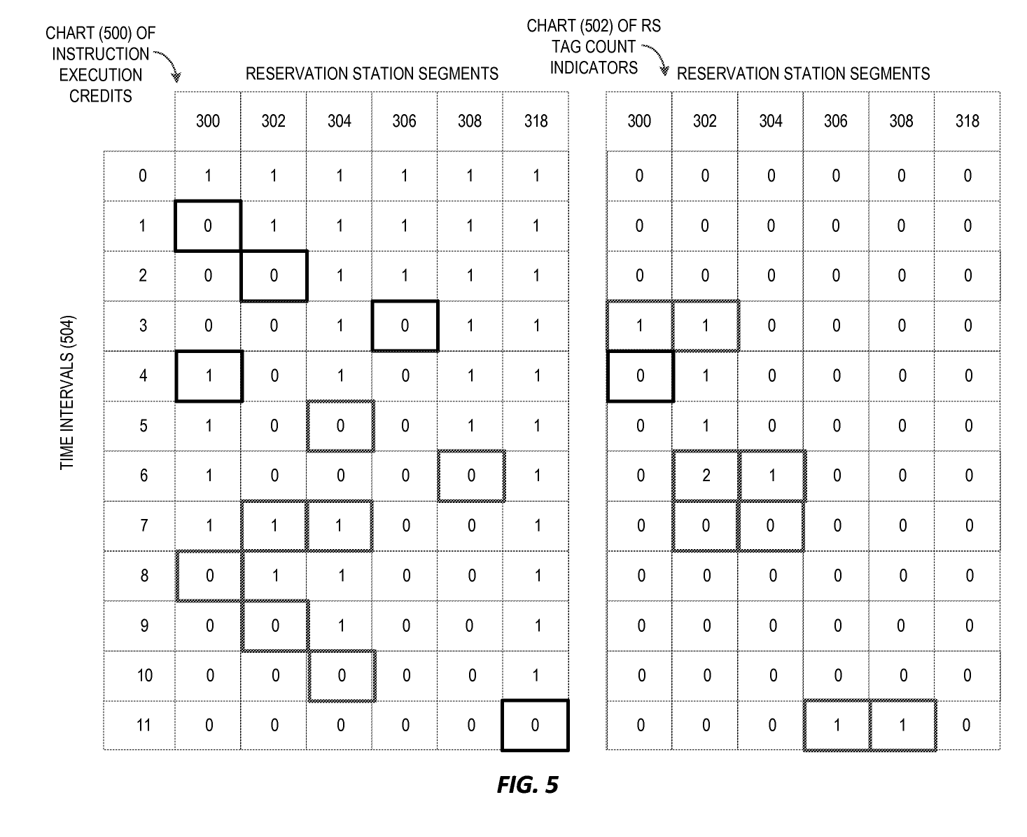

The dataflow monitor 142 may then evaluate the entries to determine whether all consumer instructions for each loop instruction have executed by comparing the consumer count indicator for each loop instruction to the corresponding RS tag count indicator. If the consumer count indicator and the RS tag count indicator are equal, the dataflow monitor 142 may conclude that all consumer instructions for the loop instruction have executed. The dataflow monitor 142 may then reset the RS tag count indicator for the loop instruction to zero (0), and issue an execution credit to the reservation station segment 124(0-X), 126(0-Y), and 128(0-Z) of the loop instruction. In this manner, the loop instruction may not be permitted to execute again until all of its consumer instructions have executed. This may enable lower-overhead management of dataflow execution of the loop instructions by, e.g., not requiring additional buffer storage space to track different operand values for different loop iterations. Elements of the entries stored by the dataflow monitor 142 are discussed in greater detail below with respect to FIG. 4, and exemplary operation of the dataflow monitor 142 for adjusting the RS tag count indicator and issuing additional execution credits is discussed in greater detail below with respect to FIG. 5.

Aspects of the dataflow monitor 142, the stream RSB 104, the compute RSB 110, and/or the load RSB 116 may employ different techniques for detecting the completion of a loop iteration. In some aspects, an RSB (i.e., one of the stream RSB 104, the compute RSB 110, and the load RSB 116) may maintain a count of instructions that have executed during a loop iteration I. When the count of instructions executed for the loop iteration I becomes equal to a number of instructions in the RSB, the RSB communicates an end loop iteration I status (not shown) to the dataflow monitor 142. Once the dataflow monitor 142 has received an end loop iteration I status from all RSBs, the dataflow monitor 142 knows that all instructions for the loop iteration I have finished execution. The dataflow monitor 142 may then issue an additional instruction execution credit 162.

Some aspects may provide that each reservation station segment 124(0-X), 126(0-Y), and 128(0-Z) includes an end bit (not shown) that signifies whether each resident instruction is a “leaf” instruction in a dataflow ordering of the instructions (i.e., an instruction on which there are no data dependencies). When all end flag instructions have executed, a loop iteration has completed. Accordingly, each resident instruction broadcasts its end flag upon execution. The dataflow monitor 142 maintains a count of the number of end flag instruction executions for a particular loop iteration I, and the total number of end flag instructions within the loop iteration I. Once the number of end flag instruction executions for the loop iteration I becomes equal to the total number of end flag instructions, the dataflow monitor 142 may conclude that all instructions for the loop iteration I have completed execution. The dataflow monitor 142 may then issue an additional instruction execution credit 162.

FIG. 2 is a diagram illustrating elements of an exemplary reservation station segment 200, such as one of the reservation station segments 124(0-X), 126(0-Y), or 128(0-Z) of FIG. 1. It is to be understood that the elements shown in FIG. 2 are for illustrative purposes only, and that some aspects of the reservation station segments 124(0-X), 126(0-Y), and/or 128(0-Z) of FIG. 1 may include more or fewer elements than shown in FIG. 2.

The reservation station segment 200 of FIG. 2 includes an RS tag 202, which serves as a unique identifier for the reservation station segment 200. The reservation station segment 200 also includes a loop instruction register 204, which stores a loop instruction (“instr”) 206 associated with the reservation station segment 200. As a non-limiting example, the loop instruction 206 may be an instruction opcode. In the example of FIG. 2, the RS tag 202 includes a 7-bit identifier (ID) tag 208 and a 1-bit end flag 210. When set, the end flag 210 indicates that the loop instruction 206 associated with the reservation station segment 200 is a “leaf” instruction. By detecting the set end flag 210 within the RS tag 202 of the loop instruction 206 that has executed, the dataflow monitor 142 of FIG. 1 may determine that a loop iteration has completed. In some aspects, a loop iteration may include more than one leaf instruction. Accordingly, the dataflow monitor 142 may be configured to track a count of leaf instructions executed within a loop iteration. It is to be understood that other aspects of the reservation station segment 200 may employ other techniques for determining that a loop iteration has completed. As a non-limiting example, an RSB of which the reservation station segment 200 is a part may maintain a count of instructions that have executed during each loop iteration.

The reservation station segment 200 also provides storage for data that may be required by the loop instruction 206 to execute. In the example of FIG. 2, the loop instruction 206 is associated with a first operand and a second operand. Accordingly, to store data associated with the first operand, the reservation station segment 200 provides an operand source RS tag 212 and an operand buffer 214(0). The operand source RS tag 212 may identify a reservation station segment (not shown) that is associated with a “producer” instruction (not shown) that generates the first operand. The operand buffer 214(0) includes one or more operand buffer entries 216(0)-216(N) and a corresponding one or more operand ready flags 218(0)-218(N). Each of the operand buffer entries 216(0)-216(N) may store an operand value generated during a corresponding loop iteration 0-N (not shown), while each operand ready flag 218(0)-218(N) may indicate when the associated operand buffer entry 216(0)-216(N) is ready for consumption by the loop instruction 206.

Similarly, to store data associated with the second operand, the reservation station segment 200 provides an operand source RS tag 220 and an operand buffer 214(1). The operand buffer 214(1) includes one or more operand buffer entries 222(0)-222(N), and a corresponding one or more operand ready flags 224(0)-224(N). The operand source RS tag 220, the operand buffer entries 222(0)-222(N), and the operand ready flags 224(0)-224(N) may function in a manner corresponding to the functionality of the operand source RS tag 212, the operand buffer entries 216(0)-216(N), and the operand ready flags 218(0)-218(N), respectively.

The reservation station segment 200 also includes an iteration counter 226. The iteration counter 226 may be set to an initial value of zero (0), and may be subsequently incremented with each execution of the loop instruction 206. A current value of the iteration counter 226 may be provided by the reservation station segment 200 when the loop instruction 206 is provided for dataflow execution. In this manner, the current value of the iteration counter 226 may be used by subsequently-executing consumer instructions to determine the loop iteration in which the loop instruction 206 executed.

The reservation station segment 200 additionally includes an instruction execution credit indicator 228, which stores an instruction execution (“instr ex”) credit 230 distributed to the reservation station segment 200 by the dataflow monitor 142 of FIG. 1. The reservation station segment 200 may be configured to provide the loop instruction 206 for execution only if the instruction execution credit indicator 228 indicates that the loop instruction 206 may be executed. For example, in some aspects, the instruction execution credit indicator 228 may comprise a counter, the value of which may be decremented after each execution of the loop instruction 206. The reservation station segment 200 may thus be configured to provide the loop instruction 206 for execution only if the instruction execution credit indicator 228 is currently storing a value greater than zero (0).

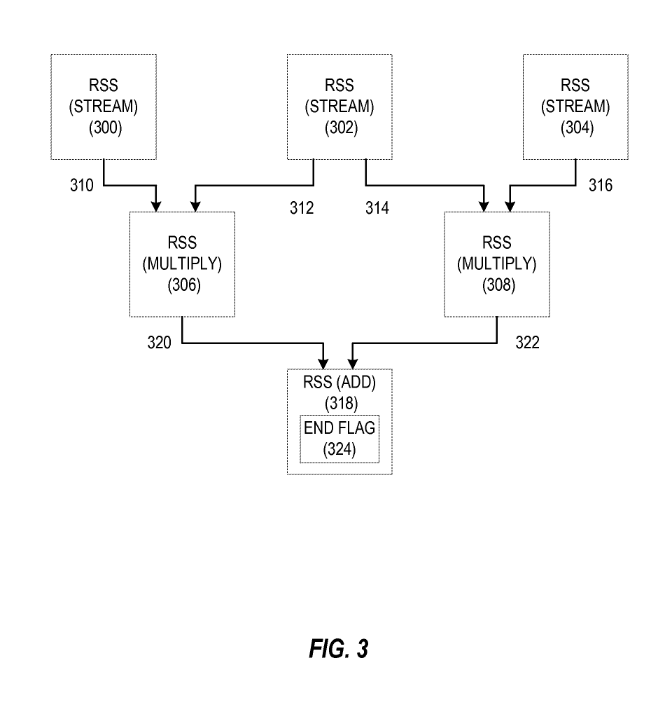

FIGS. 3-5 illustrate how exemplary reservation station segments executing instructions based on instruction execution credits, as implemented by the reservation station circuit 102 of FIG. 1, may provide lower-overhead management of dataflow execution of loop instructions. FIG. 3 shows reservation station segments and the data dependencies therebetween. FIG. 4 illustrates an initial state for dataflow monitor entries corresponding to the reservation station segments of FIG. 3. FIG. 5 illustrates how instruction execution credits may be distributed to the reservation station segments of FIG. 3 to govern dataflow execution of loop instructions during a loop iteration.

In FIG. 3, a total of six (6) reservation station segments (RSSs) are illustrated. Each RSS 300, 302, and 304 is associated with a resident stream instruction (not shown) that retrieves a data token (not shown) from a channel unit, such as the channel unit 106 of FIG. 1. For the sake of clarity, it is assumed that input for the resident stream instructions of each RSS 300, 302, and 304 are always readily available from the channel unit 106. An RSS 306 and an RSS 308 are each associated with a multiply instruction (not shown) that computes a product of two operands (not shown). The RSS 306 receives, as operands, the data provided by the RSS 300 and the RSS 302, as indicated by arrows 310 and 312, respectively. Similarly, the RSS 308 receives, as operands, the data provided by the RSS 302 and the RSS 304, as indicated by arrows 314 and 316, respectively. A data dependency thus exists between the RSS 306 and each RSS 300 and 302, and between the RSS 308 and each RSS 302 and 304. An RSS 318 is associated with an add instruction (not shown) that computes a sum of two operands. The RSS 318 receives, as operands, the results generated by the RSS 306 and the RSS 308, as indicated by arrows 320 and 322, respectively.

In the example of FIG. 3, there are no instructions dependent on the result generated by the add instruction associated with the RSS 318. Accordingly, the RSS 318 includes an end flag 324 to indicate to the dataflow monitor 142 of FIG. 1 that execution of the add instruction of the RSS 318 represents the end of one loop iteration. In some aspects, the end flag 324 may comprise a one-bit indicator stored as part of an RS tag for the RSS 318, such as the end flag 210 of the RS tag 202 of FIG. 2.

FIG. 4 illustrates a block diagram 400 of exemplary dataflow monitor entries 402, 404, 406, 408, 410, and 412, corresponding to the RSSs 300, 302, 304, 306, 308, and 318 of FIG. 3, respectively, that may be provided by the dataflow monitor 142 of FIG. 1. As seen in FIG. 4, each of the entries 402-412 includes a consumer count indicator 414 and an RS tag count indicator 416. The consumer count indicator 414 for each entry 402-412 indicates the number of consumer instructions for the loop instruction (not shown) associated with the corresponding RSS 300-308, 318. Thus, the loop instructions corresponding to the RSSs 300, 304, 306, 308, and 318 each have one consumer instruction, while the loop instruction associated with the RSS 302 has two consumer instructions. The RS tag count indicator 416 for each of the entries 402-412 is initialized to zero (0).

To illustrate how the reservation station circuit 102 of FIG. 1 may utilize the entries 402-412 of FIG. 4 to distribute instruction execution credits to each RSS 300, 302, 304, 306, 308, and 318 of FIG. 3 to manage dataflow execution of loop instructions, FIG. 5 is provided. FIG. 5 illustrates a chart 500 of instruction execution credits (such as the instruction execution credit 230 of FIG. 2), and a chart 502 of RS tag count indicators (such as the RS tag count indicator 416 of FIG. 4) as they vary over loop iterations. Each RSS 300, 302, 304, 306, 308, and 318 of FIG. 3 is represented by a column in each of the charts 500 and 502, while the rows of the charts 500 and 502 represent time intervals 504 during loop iterations. In FIG. 5, it is assumed that the instruction execution credit indicator, such as the instruction execution credit indicator 228 of FIG. 2, associated with each RSS 300, 302, 304, 306, 308, and 318 is a counter. For the sake of clarity, elements of FIGS. 1-4 are referenced in describing FIG. 5.

At time interval 0, the dataflow monitor 142 of the reservation station circuit 102 distributes an initial instruction execution credit, such as the initial instruction execution credit 160 of FIG. 1, to each RSS 300, 302, 304, 306, 308, and 318. In this example, the initial instruction execution credit 160 has a value of one (1). The dataflow monitor 142 further initializes the RS tag count indicators for each RSS 300, 302, 304, 306, 308, and 318 to zero (0) to indicate that no consumer instructions of any of the associated resident loop instructions have executed. Execution of the loop instructions then commences.

Because input data for the resident stream instructions of the RSS 300, the RSS 302, and the RSS 304 is readily available, the resident stream instructions effectively have no data dependencies. Therefore, the resident stream instructions associated with the RSS 300, the RSS 302, and the RSS 304 are eligible for dataflow execution. In the example of FIG. 5, at time interval 1, the RSS 300 provides its resident stream instruction for execution. The RSS 300 then decrements its instruction execution credit to zero (0). The result of the execution of the stream instruction associated with the RSS 300 will be broadcast to the other RSSs 302, 304, 306, 308, and 318, and will be detected and stored by the RSS 306 in an operand buffer entry such as the operand buffer entry 216 of FIG. 2. In a similar manner, the RSS 302 provides its resident stream instruction for execution, and decrements its instruction execution credit to zero (0) at time interval 2. The result of the execution of the stream instruction associated with the RSS 302 will be detected and stored as an operand by both the RSS 306 and the RSS 308. Because the instructions associated with the RSS 306 and the RSS 308 do take operands, they do not supply any operand source RS tags to the dataflow monitor 142, and accordingly the RS tag count indicators shown in chart 502 do not change through time interval 2.

At time interval 3, both operands for the resident multiply instruction of the RSS 306 have been received, and thus the resident multiply instruction is eligible for dataflow execution. The resident stream instruction for the RSS 304 is also eligible for dataflow execution, having an instruction execution credit greater than zero (0) and no effective data dependencies. In this example, the RSS 306 provides its resident multiply instruction to a functional unit, such as the functional unit 112 of FIG. 1, for execution. The RSS 306 then decrements its instruction execution credit to zero (0). The result of the execution of the multiply instruction of the RSS 306 will be received by the RSS 318 as an operand. The operand source RS tags for the RSS 306 (i.e., the RS tags for the RSS 300 and the RSS 302) will also be received by the dataflow monitor 142, which increments the RS tag count indicators for the RSS 300 and the RSS 302 to one (1). Note that at time interval 3, the data dependencies of the resident multiply instruction associated with the RSS 308 and the resident add instruction associated with the RSS 318 have not been satisfied, and thus those instructions are not eligible for dataflow execution.

At time interval 4, the dataflow monitor 142 determines that the consumer count indicator for the RSS 300 (which has a value of 1, as seen in FIG. 4) equals the RS tag count indicator for the RSS 300, as seen in the chart 502. Accordingly, the dataflow monitor 142 concludes that all consumer instructions of the loop instruction associated with the RSS 300 have executed. The dataflow monitor 142 thus issues an additional execution credit to the RSS 300, bringing its instruction execution credit to one (1), and resets the RS tag count indicator for the RSS 300 to zero (0).

At time interval 5, either of the resident stream instructions associated with the RSS 300 and the RSS 304 are eligible for dataflow execution. In the example of FIG. 5, the RSS 304 provides its resident stream instruction for execution, and decrements its instruction execution credit to zero (0). Consequently, at time interval 6, both operands (from the RSS 302 and the RSS 304) for the resident multiply instruction of the RSS 308 have been received, and thus, the resident multiply instruction is eligible for dataflow execution. Accordingly, in this example, the RSS 308 provides its resident multiply instruction to a functional unit, such as the functional unit 112 of FIG. 1, for execution. The RSS 308 then decrements its instruction execution credit to zero (0). The result of the execution of the multiply instruction of the RSS 308 will be received by the RSS 318 as an operand. The operand RS tags for the RSS 308 (i.e., the RS tags for the RSS 302 and the RSS 304) will also be received by the dataflow monitor 142, which increments the RS tag count indicator for the RSS 302 to two (2) and the RS tag count indicator for the RSS 304 to one (1).

At time interval 7, the dataflow monitor 142 determines that the consumer count indicator for the RSS 302 (which has a value of 2, as seen in FIG. 4) equals the RS tag count indicator for the RSS 302, as seen in the chart 502. Accordingly, the dataflow monitor 142 concludes that all consumer instructions of the loop instruction associated with the RSS 302 have executed. The dataflow monitor 142 thus issues an additional execution credit to the RSS 302, bringing its instruction execution credit to one (1), and resets the RS tag count indicator for the RSS 302 to zero (0). Similarly, the dataflow monitor 142 determines that the consumer count indicator for the RSS 304 (i.e., 1, as seen in FIG. 4) equals the RS tag count indicator for the RSS 304, as shown in the chart 502. The dataflow monitor 142 concludes that all consumer instructions of the loop instruction associated with the RSS 304 have executed, and issues an additional execution credit to the RSS 304, bringing its instruction execution credit to one (1). The dataflow monitor 142 also resets the RS tag count indicator for the RSS 302 to zero (0).

At time interval 8, the resident stream instructions associated with the RSS 300, the RSS 302, and the RSS 304 and the resident add instruction associated with the RSS 318 are each eligible for execution. In the example of FIG. 5, the resident stream instructions associated with the RSS 300, the RSS 302, and the RSS 304 are selected for execution during time intervals 8, 9, and 10, respectively. The instruction execution credit for each of the RSS 300, the RSS 302, and the RSS 304 is decremented to zero (0).

Finally, at time interval 11, the resident add instruction associated with the RSS 318 is the only instruction with an instruction execution credit greater than zero (0). As a result, while input data may be available to the resident instructions of the RSS 300, the RSS 302, the RSS 306, the RSS 308, and/or the RSS 318, none of the resident instructions may be executed again until additional credits are distributed by the dataflow monitor 142. This allows the resident instruction of the RSS 318 to “catch up” by providing time to consume the data produced by its producer instructions. Thus, at time interval 11, the RSS 318 provides its resident add instruction to the functional unit 112 for execution, and decrements its instruction execution credit to zero (0). The operand RS tags for the RSS 318 (i.e., the RS tags for the RSS 306 and the RSS 308) will also be received by the dataflow monitor 142, which increments the RS tag count indicators for the RSS 306 and the RSS 308 to one (1).

In some aspects, upon execution of the resident add instruction of the RSS 318, the dataflow monitor 142 may detect the end flag 324 of the RSS 318, and may determine that one iteration of the loop has completed. Accordingly, at time interval 11, the dataflow monitor 142 may distribute an additional instruction execution credit to each of the RSS 300, the RSS 302, the RSS 304, the RSS 306, the RSS 308, and the RSS 318 (not shown). In this case, distribution of the additional instruction execution credit would have the effect of incrementing the instruction execution credit associated with each RSS 300, 302, 304, 306, 308, and 318 to one (1). Dataflow execution of the resident instructions of the RSS 300, the RSS 302, the RSS 304, the RSS 306, the RSS 308, and the RSS 318 would then continue on in this manner.

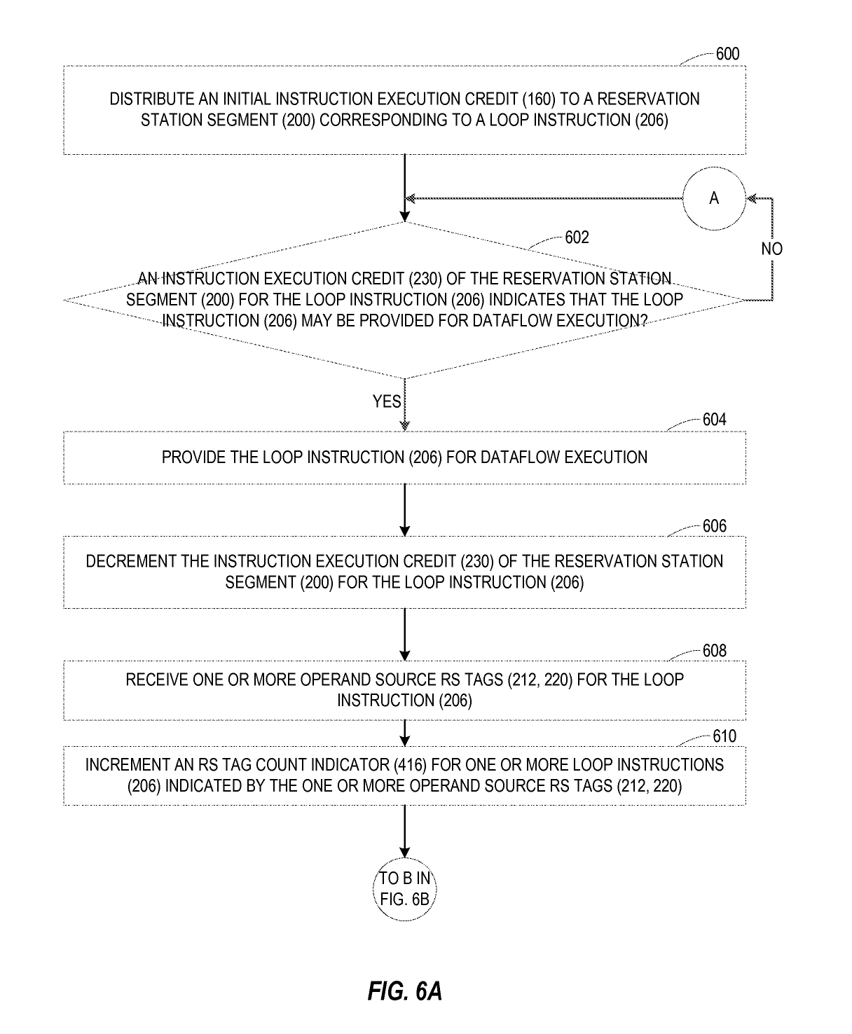

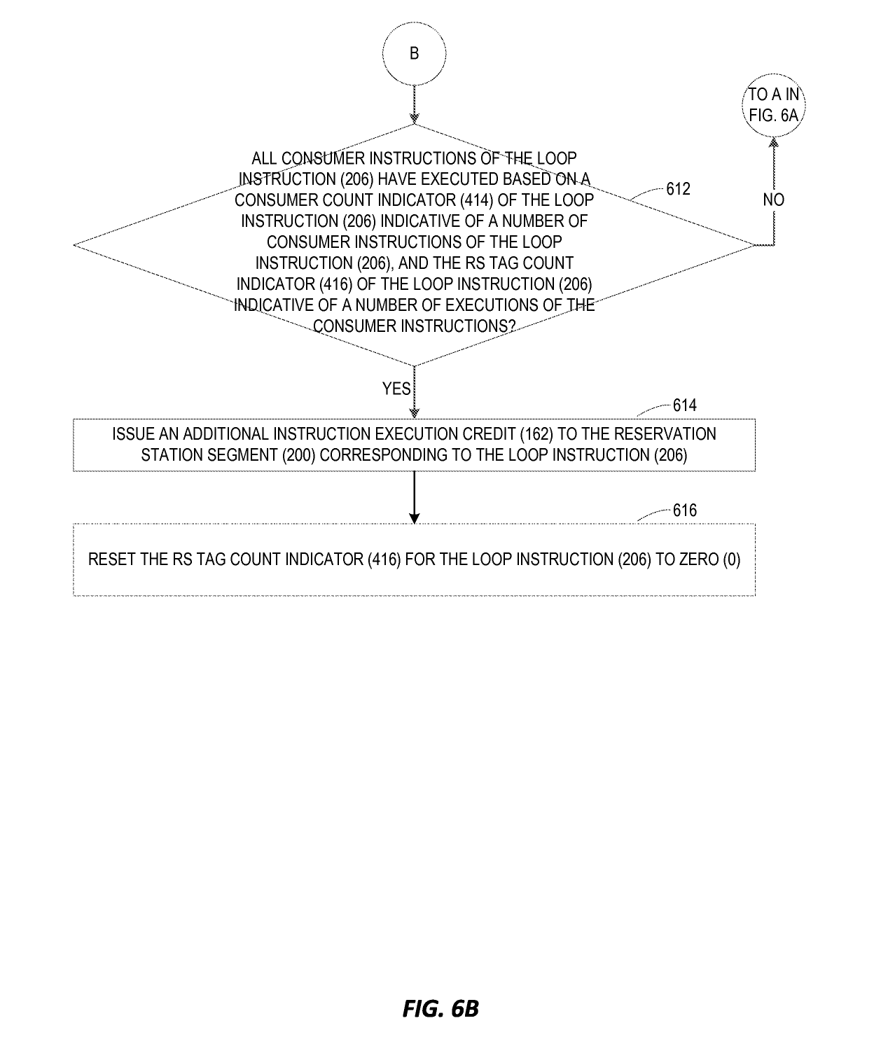

To illustrate exemplary operations for providing lower-overhead management of loop instructions in the exemplary OOP 100 of FIG. 1, FIGS. 6A and 6B are provided. FIG. 6A is a flowchart that illustrates operations for distributing initial instruction execution credits and tracking execution of consumer instructions using an RS tag count indicator such as the RS tag count indicator 416 of FIG. 4. FIG. 6B shows operations for determining whether all consumer instructions of a loop instruction have executed, and thus whether an instruction execution credit may be issued. For the sake of clarity, elements of FIGS. 1-4 are referenced in describing FIGS. 6A and 6B.

In FIG. 6A, operations begin with the dataflow monitor 142 optionally distributing an initial instruction execution credit 160 to a reservation station segment, such as the reservation station segment 200, corresponding to a loop instruction 206 (block 600). As discussed above, each reservation station segment 300, 302, 304, 306, 308, 318 may store a loop instruction 206 of a loop. The reservation station segment 200 then determines whether an instruction execution credit 230 for the reservation station segment 200 indicates that the loop instruction 206 may be provided for dataflow execution (block 602). If the instruction execution credit 230 indicates that the loop instruction 206 may not be provided for dataflow execution, processing may continue at block 602 of FIG. 6A. However, if the reservation station segment 200 determines at block 602 that the instruction execution credit 230 indicates that the loop instruction 206 may be provided for dataflow execution, the reservation station segment 200 provides the loop instruction 206 of the reservation station segment 200 for dataflow execution (block 604). In some aspects, the operations of block 604 may include the reservation station segment 200 determining that one or more operand buffers 214 of the reservation station segment 200 contain one or more operands required by the loop instruction 206. The reservation station segment 200 may then provide the loop instruction 206 and the one or more operands for dataflow execution.

After the loop instruction 206 is provided for dataflow execution, the reservation station segment 200 may decrement the instruction execution credit 230 of the loop instruction 206 (block 606). The dataflow monitor 142 may then receive one or more operand source RS tags 212, 220 for the loop instruction 206 (block 608). The dataflow monitor 142 next may increment an RS tag count indicator 416 for one or more entries 402-412 indicated by the one or more operand source RS tags 212, 220 (block 610). Processing then resumes at block 612 of FIG. 6B.

Referring now to FIG. 6B, the dataflow monitor 142 determines whether all consumer instructions of the loop instruction 206 have executed based on a consumer count indicator 414 and the RS tag count indicator 416 of the loop instruction 206 (block 612). In some aspects, the consumer count indicator 414 is indicative of a number of consumer instructions of the loop instruction 206, while the RS tag count indicator 416 is indicative of a number of executions of the consumer instructions. Some aspects may provide that the dataflow monitor 142 determines whether all consumer instructions of the loop instruction 206 have executed by determining whether the consumer count indicator 414 and the RS tag count indicator 416 of the loop instruction 206 are equal. If the dataflow monitor 142 determines at block 612 that not all consumer instructions of the loop instruction 206 have executed, processing may resume at block 602 of FIG. 6A. However, if the dataflow monitor 142 determines at block 612 that all consumer instructions of the loop instruction 206 have executed, the dataflow monitor 142 issues an additional instruction execution credit 162 to the reservation station segment 200 corresponding to the loop instruction 206 (block 614). The dataflow monitor 142 may then reset the RS tag count indicator 416 for the loop instruction 206 to zero (0) (block 616). In this manner, the dataflow monitor 142 may provide low-overhead management of dataflow execution of loop instructions by tracking the execution of consumer instructions of a loop instruction, and issuing an instruction execution credit to the loop instruction when all consumer instructions of the loop instruction have executed.

Providing lower-overhead management of dataflow execution of loop instructions by OOPs, and related circuits, methods, and computer-readable media, according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

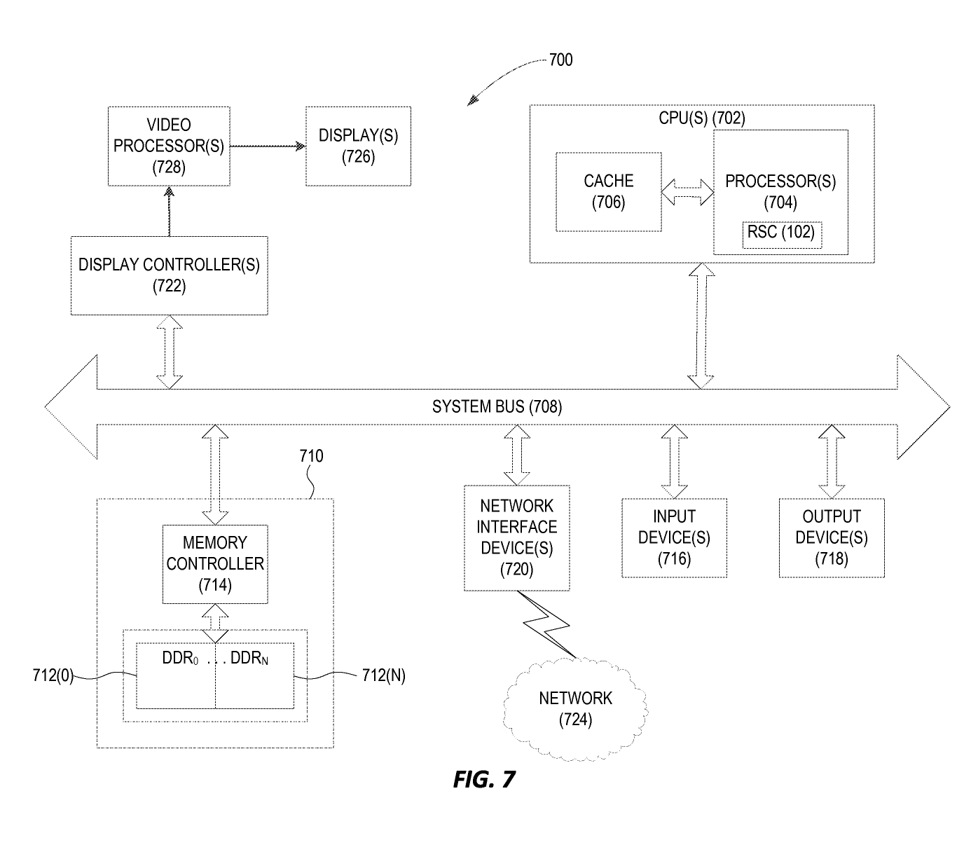

In this regard, FIG. 7 illustrates an example of a processor-based system 700 that can employ the reservation station circuit 102 illustrated in FIG. 1. In this example, the processor-based system 700 includes one or more central processing units (CPUs) 702, each including one or more processors 704 that may comprise the reservation station circuit (RSC) 102 of FIG. 1. The CPU(s) 702 may have cache memory 706 coupled to the processor(s) 704 for rapid access to temporarily stored data. The CPU(s) 702 is coupled to a system bus 708 and can intercouple master and slave devices included in the processor-based system 700. As is well known, the CPU(s) 702 communicates with these other devices by exchanging address, control, and data information over the system bus 708. For example, the CPU(s) 702 can communicate bus transaction requests to a memory system 710, which provides memory units 712(0)-712(N).

Other master and slave devices can be connected to the system bus 708. As illustrated in FIG. 7, these devices can include a memory controller 714, one or more input devices 716, one or more output devices 718, one or more network interface devices 720, and one or more display controllers 722, as examples. The input device(s) 716 can include any type of input device, including but not limited to input keys, switches, voice processors, etc. The output device(s) 718 can include any type of output device, including but not limited to audio, video, other visual indicators, etc. The network interface device(s) 720 can be any devices configured to allow exchange of data to and from a network 724. The network 724 can be any type of network, including but not limited to a wired or wireless network, a private or public network, a local area network (LAN), a wide local area network (WLAN), and the Internet. The network interface device(s) 720 can be configured to support any type of communications protocol desired.

The CPU(s) 702 may also be configured to access the display controller(s) 722 over the system bus 708 to control information sent to one or more displays 726. The display controller(s) 722 sends information to the display(s) 726 to be displayed via one or more video processors 728, which process the information to be displayed into a format suitable for the display(s) 726. The display(s) 726 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A reservation station circuit for managing dataflow execution of loop instructions in an out-of-order processor (OOP), comprising:
a plurality of reservation station segments, each comprising:
a loop instruction register configured to store a loop instruction; and
an instruction execution credit indicator configured to store an instruction execution credit indicative of whether the loop instruction may be provided for dataflow execution; and
a dataflow monitor comprising a plurality of entries corresponding to the loop instructions of the plurality of reservation station segments, each entry comprising:
a consumer count indicator indicative of a number of consumer instructions of a corresponding loop instruction; and
a reservation station (RS) tag count indicator indicative of a number of executions of the consumer instructions;
the dataflow monitor configured to:
determine whether all of the consumer instructions of a first loop instruction have executed based on the consumer count indicator and the RS tag count indicator for the first loop instruction; and
responsive to determining that all of the consumer instructions of the first loop instruction have executed, issue an instruction execution credit to a reservation station segment of the first loop instruction.

2. The reservation station circuit of claim 1, wherein the dataflow monitor is configured to determine whether all of the consumer instructions of the first loop instruction have executed by determining whether the consumer count indicator and the RS tag count indicator for the first loop instruction are equal.

3. The reservation station circuit of claim 1, wherein the dataflow monitor is further configured to, responsive to determining that all of the consumer instructions of the first loop instruction have executed, reset the RS tag count indicator for the first loop instruction to zero (0).

4. The reservation station circuit of claim 1, wherein the dataflow monitor is further configured to, upon execution of a second loop instruction:
receive one or more operand source RS tags for the second loop instruction; and
increment the RS tag count indicator for each entry of the plurality of entries indicated by the one or more operand source RS tags.

5. The reservation station circuit of claim 1, wherein the dataflow monitor is further configured to distribute an initial instruction execution credit to the instruction execution credit indicator of each reservation station segment of the plurality of reservation station segments.

6. The reservation station circuit of claim 1, where each reservation station segment of the plurality of reservation station segments is configured to repeatedly:
determine whether the instruction execution credit of the instruction execution credit indicator for the reservation station segment indicates that the loop instruction may be provided for dataflow execution; and
responsive to determining that the instruction execution credit indicates that the loop instruction may be provided for dataflow execution:
provide the loop instruction of the reservation station segment for dataflow execution; and
decrement the instruction execution credit for the reservation station segment.

7. The reservation station circuit of claim 1 integrated into an integrated circuit (IC).

8. The reservation station circuit of claim 1 integrated into a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

9. A method for managing dataflow execution of loop instructions in an out-of-order processor (OOP), comprising:
determining, by a dataflow monitor, whether all consumer instructions of a first loop instruction have executed based on a consumer count indicator of the first loop instruction indicative of a number of the consumer instructions of the first loop instruction, and a reservation station (RS) tag count indicator of the first loop instruction indicative of a number of executions of the consumer instructions; and
responsive to determining that all of the consumer instructions of the first loop instruction have executed, issuing an instruction execution credit to a reservation station segment corresponding to the first loop instruction.

10. The method of claim 9, wherein determining whether all of the consumer instructions of the first loop instruction have executed comprises determining whether the consumer count indicator and the RS tag count indicator for the first loop instruction are equal.

11. The method of claim 9, further comprising, responsive to determining that all of the consumer instructions of the first loop instruction have executed, resetting the RS tag count indicator for the first loop instruction to zero (0).

12. The method of claim 9, further comprising, upon execution of a second loop instruction:
receiving one or more operand source RS tags for the second loop instruction; and
incrementing the RS tag count indicator for one or more loop instructions indicated by the one or more operand source RS tags.

13. The method of claim 9, further comprising distributing an initial instruction execution credit to the reservation station segment corresponding to the first loop instruction.

14. The method of claim 9, further comprising, for each loop instruction of a plurality of reservation station segments:
determining whether the instruction execution credit of the reservation station segment for the loop instruction indicates that the loop instruction may be provided for dataflow execution; and
responsive to determining that the instruction execution credit of the reservation station segment for the loop instruction indicates that the loop instruction may be provided for dataflow execution:
providing the loop instruction for dataflow execution; and
decrementing the instruction execution credit of the reservation station segment for the loop instruction.

15. A non-transitory computer-readable medium having stored thereon computer-executable instructions which, when executed by a processor, cause the processor to:
determine, by a dataflow monitor, whether all consumer instructions of a first loop instruction have executed based on a consumer count indicator of the first loop instruction indicative of a number of the consumer instructions of the first loop instruction, and a reservation station (RS) tag count indicator of the first loop instruction indicative of a number of executions of the consumer instructions; and
responsive to determining that all of the consumer instructions of the first loop instruction have executed, issue an instruction execution credit to a reservation station segment corresponding to the first loop instruction.

16. The non-transitory computer-readable medium of claim 15 having stored thereon computer-executable instructions which, when executed by the processor, further cause the processor to determine whether all of the consumer instructions of the first loop instruction have executed by determining whether the consumer count indicator and the RS tag count indicator for the first loop instruction are equal.

17. The non-transitory computer-readable medium of claim 15 having stored thereon computer-executable instructions which, when executed by the processor, further cause the processor to, responsive to determining that all of the consumer instructions of the first loop instruction have executed, reset the RS tag count indicator for the first loop instruction to zero (0).

18. The non-transitory computer-readable medium of claim 15 having stored thereon computer-executable instructions which, when executed by the processor, further cause the processor to, upon execution of a second loop instruction:
receive one or more operand source RS tags for the second loop instruction; and
increment the RS tag count indicator for one or more loop instructions indicated by the one or more operand source RS tags.

19. The non-transitory computer-readable medium of claim 15 having stored thereon computer-executable instructions which, when executed by the processor, further cause the processor to distribute an initial instruction execution credit to the reservation station segment corresponding to the first loop instruction.

20. The non-transitory computer-readable medium of claim 15 having stored thereon computer-executable instructions which, when executed by the processor, further cause the processor to, for each loop instruction of a plurality of reservation station segments:
determine whether the instruction execution credit of the reservation station segment for the loop instruction indicates that the loop instruction may be provided for dataflow execution; and
responsive to determining that the instruction execution credit of the reservation station segment for the loop instruction indicates that the loop instruction may be provided for dataflow execution:
provide the loop instruction for dataflow execution; and
decrement the instruction execution credit of the reservation station segment for the loop instruction.
